(19) United States
(12) Patent Application Publication
(10) Pub. No.: US 2006/0074912 A1
(43) Pub. Date: Apr. 6, 2006

(54) System and method for determining file system content relevance

(75) Inventors: Dhrubajyoti Borthakur, San Jose, CA (US); Serge Pashenkov, Redwood City, CA (US)

Correspondence Address: MEYERTONS, HOOD, KIVLIN, KOWERT & GOETZEL, P.C., P.O. BOX 398, AUSTIN, TX, 78767-0398, US

(73) Assignee: VERITAS Operating Corporation

(21) Appl. No.: 10/951,511

(22) Filed: Sep. 28, 2004

(51) Int. Cl. G06F 17/30

(52) U.S. Cl. 707/9

(57) ABSTRACT

A system and method for determining file system content relevance. According to a first embodiment, the system may include a storage device configured to store data and a file system configured to manage access to the storage device and to store file system content including a plurality of files. The system may further include a search engine configured to search the file system content and to produce a result set indicating one or more of the plurality of files. Each of the files indicated in the result set may be associated with a respective relevance indication, and a given relevance indication may be dependent upon content access information corresponding to the associated file.

### BACKGROUND

1. Field of the Invention

This invention relates to computer systems and, more particularly, to file-based storage systems.

2. Description of the Related Art

Computer systems often process large quantities of information, including application data and executable code configured to process such data. In numerous embodiments, computer systems provide various types of mass storage devices configured to store data, such as magnetic and optical disk drives, tape drives, etc. To provide a regular and systematic interface through which to access their stored data, such storage devices are frequently organized into hierarchies of files by software such as an operating system. Often a file defines a minimum level of data granularity that a user can manipulate within a storage device, although various applications and operating system processes may operate on data within a file at a lower level of granularity than the entire file.

As the number of files and the amount of data stored therein increases, efficiently locating and retrieving file data becomes more challenging. Various kinds of search technology may be employed to locate data satisfying specified characteristics, such as file names or data patterns stored within files. However, not all data that satisfies a set of search characteristics may be equally relevant to a user. Some search engines attempt to qualify the relevance of search results by examining characteristics of file content with respect to search terms, for example by giving different weight to search terms that appear in one section of a document versus another. However, determining the relevance of a file solely on its content may overlook other factors impacting relevance, potentially resulting in suboptimal guidance to users in interpreting search results.

### SUMMARY

Various embodiments of a system and method for determining file system content relevance are disclosed. According to a first embodiment, the system may include a storage device configured to store data and a file system configured to manage access to the storage device and to store file system content including a plurality of files. The system may further include a search engine configured to search the file system content and to produce a result set indicating one or more of the plurality of files. Each of the files indicated in the result set may be associated with a respective relevance indication, and a given relevance indication may be dependent upon content access information corresponding to the associated file.

In one specific implementation of the system, the search engine may be further configured to order the files indicated in the result set dependent upon their respective relevance indications.

According to a second embodiment, the system may include a storage device configured to store data and a file system configured to manage access to the storage device and to store file system content including a plurality of files, where the file system content further includes content access information dependent upon content access operations associated with the plurality of files. The system may further include a search engine configured to search the file system content and to present results dependent upon the content access information.

A method is further contemplated, which in one embodiment may include storing file system content including a plurality of files, searching the file system content; and in response to searching the file system content, producing a result set indicating one or more of the plurality of files, where each of the files indicated in the result set may be associated with a respective relevance indication, and where a given relevance indication may be dependent upon content access information corresponding to the associated file.

### BRIEF DESCRIPTION OF THE DRAWINGS

FIG. 1 is a block diagram illustrating one embodiment of a storage system.

FIG. 2 is a block diagram illustrating one embodiment of a software-based storage system architecture and its interface to storage devices.

FIG. 3 is a block diagram illustrating one embodiment of a storage management system.

FIG. 4 is a block diagram illustrating one embodiment of a file system configured to store files and associated metadata.

FIG. 5 is a block diagram illustrating one embodiment of a system configured to determine content access information-based search relevance.

FIG. 6 is a block diagram illustrating another embodiment of a system configured to determine content access information-based search relevance.

FIG. 7 is a flow diagram illustrating one embodiment of a method of determining content access information-based search relevance.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Computer System Overview

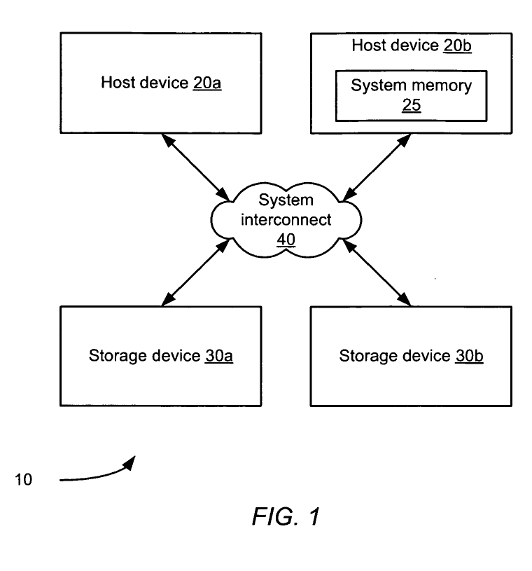

Turning now to FIG. 1, a block diagram of one embodiment of a computer system is shown. In the illustrated embodiment, system 10 includes a plurality of host devices 20a and 20b coupled to a plurality of storage devices 30a and 30b via a system interconnect 40. Further, host device 20b includes a system memory 25 in the illustrated embodiment. For simplicity of reference, elements referred to herein by a reference number followed by a letter may be referred to collectively by the reference number alone. For example, host devices 20a and 20b and storage devices 30a and 30b may be referred to collectively as host devices 20 and storage devices 30.

In various embodiments of system 10, host devices 20 may be configured to access data stored on one or more of storage devices 30. In one embodiment, system 10 may be implemented within a single computer system, for example as an integrated storage server. In such an embodiment, for example, host devices 20 may be individual processors, system memory 25 may be a cache memory such as a static RAM (SRAM), storage devices 30 may be mass storage devices such as hard disk drives or other writable or rewritable media, and system interconnect 40 may include a peripheral bus interconnect such as a Peripheral Component Interface (PCI) bus. In some such embodiments, system interconnect 40 may include several types of interconnect between host devices 20 and storage devices 30. For example, system interconnect 40 may include one or more processor buses (not shown) configured for coupling to host devices 20, one or more bus bridges (not shown) configured to couple the processor buses to one or more peripheral buses, and one or more storage device interfaces (not shown) configured to couple the peripheral buses to storage devices 30. Storage device interface types may in various embodiments include the Small Computer System Interface (SCSI), AT Attachment Packet Interface (ATAPI), Firewire, and/or Universal Serial Bus (USB), for example, although numerous alternative embodiments including other interface types are possible and contemplated.

In an embodiment of system 10 implemented within a single computer system, system 10 may be configured to provide most of the data storage requirements for one or more other computer systems (not shown), and may be configured to communicate with such other computer systems. In an alternative embodiment, system 10 may be configured as a distributed storage system, such as a storage area network (SAN), for example. In such an embodiment, for example, host devices 20 may be individual computer systems such as server systems, system memory 25 may be comprised of one or more types of dynamic RAM (DRAM), storage devices 30 may be standalone storage nodes each including one or more hard disk drives or other types of storage, and system interconnect 40 may be a communication network such as Ethernet or Fibre Channel. A distributed storage configuration of system 10 may facilitate scaling of storage system capacity as well as data bandwidth between host and storage devices.

In still another embodiment, system 10 may be configured as a hybrid storage system, where some storage devices 30 are integrated within the same computer system as some host devices 20, while other storage devices 30 are configured as standalone devices coupled across a network to other host devices 20. In such a hybrid storage system, system interconnect 40 may encompass a variety of interconnect mechanisms, such as the peripheral bus and network interconnect described above.

It is noted that although two host devices 20 and two storage devices 30 are illustrated in FIG. 1, it is contemplated that system 10 may have an arbitrary number of each of these types of devices in alternative embodiments. Also, in some embodiments of system 10, more than one instance of system memory 25 may be employed, for example in other host devices 20 or storage devices 30. Further, in some embodiments, a given system memory 25 may reside externally to host devices 20 and storage devices 30 and may be coupled directly to a given host device 20 or storage device 30 or indirectly through system interconnect 40.

In many embodiments of system 10, one or more host devices 20 may be configured to execute program instructions and to reference data, thereby performing a computational function. In some embodiments, system memory 25 may be one embodiment of a computer-accessible medium configured to store such program instructions and data. However, in other embodiments, program instructions and/or data may be received, sent or stored upon different types of computer-accessible media. Generally speaking, a computer-accessible medium may include storage media or memory media such as magnetic or optical media, e.g., disk or CD-ROM included in system 10 as storage devices 30. A computer-accessible medium may also include volatile or non-volatile media such as RAM (e.g. SDRAM, DDR SDRAM, RDRAM, SRAM, etc.), ROM, etc, that may be included in some embodiments of system 10 as system memory 25. Further, a computer-accessible medium may include transmission media or signals such as electrical, electromagnetic, or digital signals, conveyed via a communication medium such as network and/or a wireless link, which may be included in some embodiments of system 10 as system interconnect 40.

In some embodiments, program instructions and data stored within a computer-accessible medium as described above may implement an operating system that may in turn provide an environment for execution of various application programs. For example, a given host device 20 may be configured to execute a version of the Microsoft Windows operating system, the Unix/Linux operating system, the Apple Macintosh operating system, or another suitable operating system. Additionally, a given host device may be configured to execute application programs such as word processors, web browsers and/or servers, email clients and/or servers, and multimedia applications, among many other possible applications.

During execution on a given host device 20, either the operating system or a given application may generate requests for data to be loaded from or stored to a given storage device 30. For example, code corresponding to portions of the operating system or an application itself may be stored on a given storage device 30, so in response to invocation of the desired operation system routine or application program, the corresponding code may be retrieved for execution. Similarly, operating system or application execution may produce data to be stored

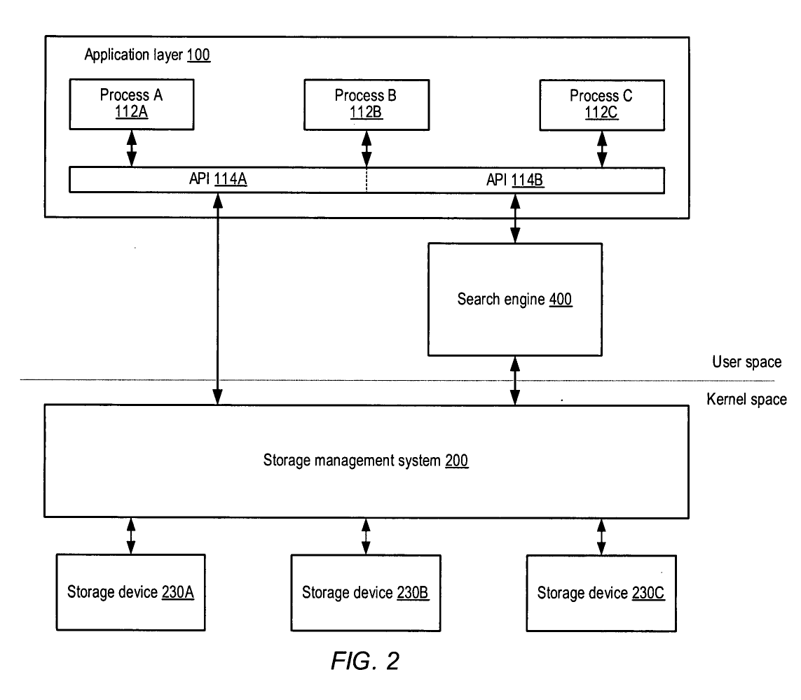

In some embodiments, the movement and processing of data stored on storage devices 30 may be managed by a software-based storage management system. One such embodiment is illustrated in FIG. 2, which shows an application layer 100 interfacing to a plurality of storage devices 230A-C via a storage management system 200. Additionally, application layer 100 interfaces to a search engine 400, which in turn interfaces to storage management system 200. Some modules illustrated within FIG. 2 may be configured to execute in a user execution mode or “user space”, while others may be configured to execute in a kernel execution mode or “kernel space.” In the illustrated embodiment, application layer 100 includes a plurality of user space software processes 112A-C. Each process interfaces to kernel space storage management system 200 via an application programming interface (API) 114A. In turn, storage management system 200 interfaces to storage devices 230A-C. Additionally, each process interfaces to user space search engine 400 via an API 114B. The functionality associated with various embodiments of storage management system 200 and search engine 400 is described in greater detail below.

It is contemplated that in some embodiments, an arbitrary number of processes 112 and/or storage devices 230 may be implemented. In one embodiment, each of processes 112 may correspond to a given user application, and each may be configured to access storage devices 230A-C through calls to API 114A. APIs 114A-B provides processes 112 with access to various components of storage management system 200 and search engine 400. For example, in one embodiment APIs 114A-B may include function calls exposed by storage management system 200 or search engine 400 that a given process 112 may invoke, while in other embodiments APIs 114A-B may support other types of interprocess communication. In one embodiment, storage devices 230 may be illustrative of storage devices 30 of FIG. 1. Additionally, in one embodiment, any of the components of storage management system 200, search engine 400 and/or any of processes 112 may be configured to execute on one or more host devices 20 of FIG. 1, for example as program instructions and data stored within a computer-accessible medium such as system memory 25 of FIG. 1.

Storage Management System and File System

As just noted, in some embodiments storage management system 200 may provide data and control structures for organizing the storage space provided by storage devices 230 into files. In various embodiments, the data structures may include one or more tables, lists, or other records configured to store information such as, for example, the identity of each file, its location within storage devices 230 (e.g., a mapping to a particular physical location within a particular storage device), as well as other information about each file as described in greater detail below. Also, in various embodiments, the control structures may include executable routines for manipulating files, such as, for example, function calls for changing file identities and for modifying file content. Collectively, these data and control structures may be referred to herein as a file system, and the particular data formats and protocols implemented by a given file system may be referred to herein as the format of the file system.

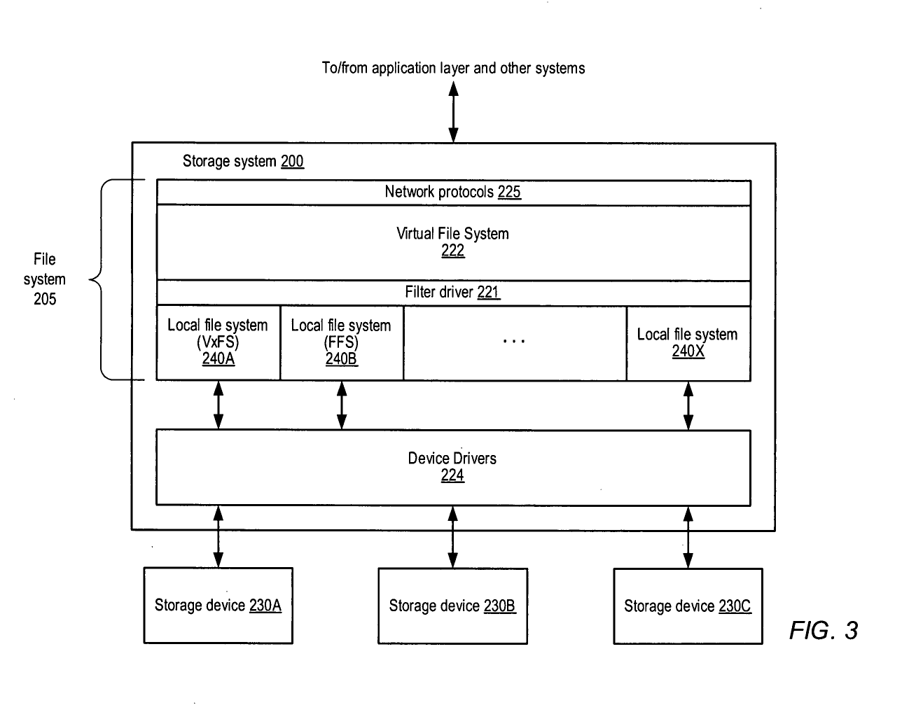

In some embodiments, a file system may be integrated into an operating system such that any access to data stored on storage devices 230 is governed by the control and data structures of the file system. Different operating systems may implement different native file systems using different formats, but in some embodiments, a given operating system may include a file system that supports multiple different types of file system formats, including file system formats native to other operating systems. In such embodiments, the various file system formats supported by the file system may be referred to herein as local file systems. Additionally, in some embodiments, a file system may be implemented using multiple layers of functionality arranged in a hierarchy, as illustrated in FIG. 3.

FIG. 3 illustrates one embodiment of storage management system 200. In the illustrated embodiment, storage management system includes a file system 205 configured to interface with one or more device drivers 224, which are in turn configured to interface with storage devices 230. As illustrated in FIG. 2, the components of storage management system 200 may be configured to execute in kernel space; however, it is contemplated that in some embodiments, some components of storage management system 200 may be configured to execute in user space. Also, in one embodiment, any of the components of storage management system 200 may be configured to execute on one or more host devices 20 of FIG. 1, for example as program instructions and data stored within a computer-accessible medium such as system memory 25 of FIG. 1.

As described above with respect to system 10 of FIG. 1, a given host device 20 may reside in a different computer system from a given storage device 30, and may access that storage device via a network. Likewise, with respect to storage management system 200, in one embodiment a given process such as process 112A may execute remotely and may access storage devices 230 over a network. In the illustrated embodiment, file system 205 includes network protocols 225 to support access to the file system by remote processes. In some embodiments, network protocols 225 may include support for the Network File System (NFS) protocol or the Common Internet File System (CIFS) protocol, for example, although it is contemplated that any suitable network protocol may be employed, and that multiple such protocols may be supported in some embodiments.

File system 205 may be configured to support a plurality of local file systems. In the illustrated embodiment, file system 205 includes a VERITAS (VxFS) format local file system 240A, a Berkeley fast file system (FFS) format local file system 240B, and a proprietary (X) format local file system 240X. However, it is contemplated that in other embodiments, any number or combination of local file system formats may be supported by file system 205. To provide a common interface to the various local file systems 240, file system 205 includes a virtual file system 222. In one embodiment, virtual file system 222 may be configured to translate file system operations originating from processes 112 to a format applicable to the particular local file system 240 targeted by each operation. Additionally, in the illustrated embodiment storage management system 200 includes device drivers 224 through which local file systems 240 may access storage devices 230. Device drivers 224 may implement data transfer protocols specific to the types of interfaces employed by storage devices 230. For example, in one embodiment device drivers 224 may provide support for transferring data across SCSI and ATAPI interfaces, though in other embodiments device drivers 224 may support other types and combinations of interfaces.

In the illustrated embodiment, file system 205 also includes filter driver 221. In some embodiments, filter driver 221 may be configured to monitor each operation entering file system 205 and, subsequent to detecting particular types of operations, to cause additional operations to be performed or to alter the behavior of the detected operation. For example, in one embodiment filter driver 221 may be configured to combine multiple write operations into a single write operation to improve file system performance. In another embodiment, filter driver 221 may be configured to compute a signature of a file subsequent to detecting a write to that file. In still another embodiment, filter driver 221 may be configured to store and/or publish information, such as records, associated with particular files subsequent to detecting certain kinds of operations on those files, as described in greater detail below. It is contemplated that in some embodiments, filter driver 221 may be configured to implement one or more combinations of the aforementioned operations, including other filter operations not specifically mentioned.

An embodiment of filter driver 221 that is configured to detect file system operations as they are requested or processed may be said to perform “in-band” detection of such operations. Alternatively, such detection may be referred to as being synchronous with respect to occurrence of the detected operation or event. In some embodiments, a processing action taken in response to in-band detection of an operation may affect how the operation is completed. For example, in-band detection of a file read operation might result in cancellation of the operation if the source of the operation is not sufficiently privileged to access the requested file. In some embodiments, in-band detection of an operation may not lead to any effect on the completion of the operation itself, but may spawn an additional operation, such as to record the occurrence of the detected operation in a metadata record as described below.

By contrast, a file system operation or event may be detected subsequent to its occurrence, such that detection may occur after the operation or event has already completed. Such detection may be referred to as “out of band” or asynchronous with respect to the detected operation or event. For example, a user process 112 may periodically check a file to determine its length. The file length may have changed at any time since the last check by user process 112, but the check may be out of band with respect to the operation that changed the file length. In some instances, it is possible for out of band detection to fail to detect certain events. Referring to the previous example, the file length may have changed several times since the last check by user process 112, but only the last change may be detected.

It is noted that although an operation or event may be detected in-band, an action taken in response to such detection may occur either before or after the detected operation completes. Referring to the previous example, in one embodiment each operation to modify the length of the checked file may be detected in-band and recorded. User process 112 may be configured to periodically inspect the records to determine the file length. Because length-modifying operations were detected and recorded in-band, user process 112 may take each such operation into account, even though it may be doing so well after the occurrence of these operations.

It is noted that filter driver 221 is part of file system 205 and not an application or process within user space 210. Consequently, filter driver 221 may be configured to operate independently of applications and processes within the user space 210. Alternatively, or in addition to the above, filter driver 221 may be configured to perform operations in response to requests received from applications or processes within the user space 210.

It is further noted that in some embodiments, kernel space 220 may include processes (not shown) that generate accesses to storage devices 230, similar to user space processes 112. In such embodiments, processes executing in kernel space 220 may be configured to access file system 205 through a kernel-mode API (not shown), in a manner similar to user space processes 112. Thus, in some embodiments, all accesses to storage devices 230 may be processed by file system 205, regardless of the type or space of the process originating the access operation.

Numerous alternative embodiments of storage management system 200 and file system 205 are possible and contemplated. For example, file system 205 may support different numbers and formats of local file systems 240, or only a single local file system 240. In some embodiments, network protocol 225 may be omitted or integrated into a portion of storage management system 200 external to file system 205. Likewise, in some embodiments virtual file system 222 may be omitted or disabled, for example if only a single local file system 240 is in use. Additionally, in some embodiments filter driver 221 may be implemented within a different layer of file system 205. For example, in one embodiment, filter driver 221 may be integrated into virtual file system 222, while in another embodiment, an instance of filter driver 221 may be implemented in each of local file systems 240.

Files and Metadata

As described above, file system 205 may be configured to manage access to data stored on storage devices 230, for example as a plurality of files stored on storage devices 230. In many embodiments, each stored file may have an associated identity used by the file system to distinguish each file from other files. In one embodiment of file system 205, the identity of a file may be a file name, which may for example include a string of characters such as “filename.txt”. However, in embodiments of file system 205 that implement a file hierarchy, such as a hierarchy of folders or directories, all or part of the file hierarchy may be included in the file identity. For example, a given file named “file1.txt” may reside in a directory “smith” that in turn resides in a directory “users”. The directory “users” may reside in a directory “test1” that is a top-level or root-level directory within file system 205. In some embodiments, file system 205 may define a single “root directory” to include all root-level directories, where no higher-level directory includes the root directory. In other embodiments, multiple top-level directories may coexist such that no higher-level directory includes any top-level directory. The names of the specific folders or directories in which a given file is located may be referred to herein as the given file's path or path name.

In some embodiments of file system 205 that implement a file hierarchy, a given file's identity may be specified by listing each directory in the path of the file as well as the file name. Referring to the example given above, the identity of the given instance of the file named “file1.txt” may be specified as “/test1/users/smith/file1.txt”. It is noted that in some embodiments of file system 205, a file name alone may be insufficient to uniquely identify a given file, whereas a fully specified file identity including path information may be sufficient to uniquely identify a given file. There may, for example, exist a file identified as “/test2/users/smith/file1.txt” that, despite sharing the same file name as the previously mentioned file, is distinct by virtue of its path. It is noted that other methods of representing a given file identity using path and file name information are possible and contemplated. For example, different characters may be used to delimit directory/folder names and file names, or the directory/folder names and file names may be specified in a different order.

The files managed by file system 205 may store application data or program information, which may collectively be referred to as file data, in any of a number of encoding formats. For example, a given file may store plain text in an ASCII-encoded format or data in a proprietary application format, such as a particular word processor or spreadsheet encoding format. Additionally, a given file may store video or audio data or executable program instructions in a binary format. It is contemplated that numerous other types of data and encoding formats, as well as combinations of data and encoding formats, may be used in files as file data.

In addition to managing access to storage devices, the various files stored on storage devices, and the file data in those files as described above, in some embodiments file system 205 may be configured to store information corresponding to one or more given files, which information may be referred to herein as metadata. Generally speaking, metadata may encompass any type of information associated with a file. In various embodiments, metadata may include information such as (but not limited to) the file identity, size, ownership, and file access permissions. Metadata may also include free-form or user-defined data such as records corresponding to file system operations, as described in greater detail below. In some embodiments, the information included in metadata may be predefined (i.e., hardcoded) into file system 205, for example as a collection of metadata types defined by a vendor or integrator of file system 205. In other embodiments, file system 205 may be configured to generate new types of metadata definitions during operation. In still other embodiments, one or more application processes 112 external to file system 205 may define new metadata to be managed by file system 205, for example via an instance of API 114 defined for that purpose. It is contemplated that combinations of such techniques of defining metadata may be employed in some embodiments. Metadata corresponding to files (however the metadata is defined) as well as the data content of files may collectively be referred to herein as file system content.

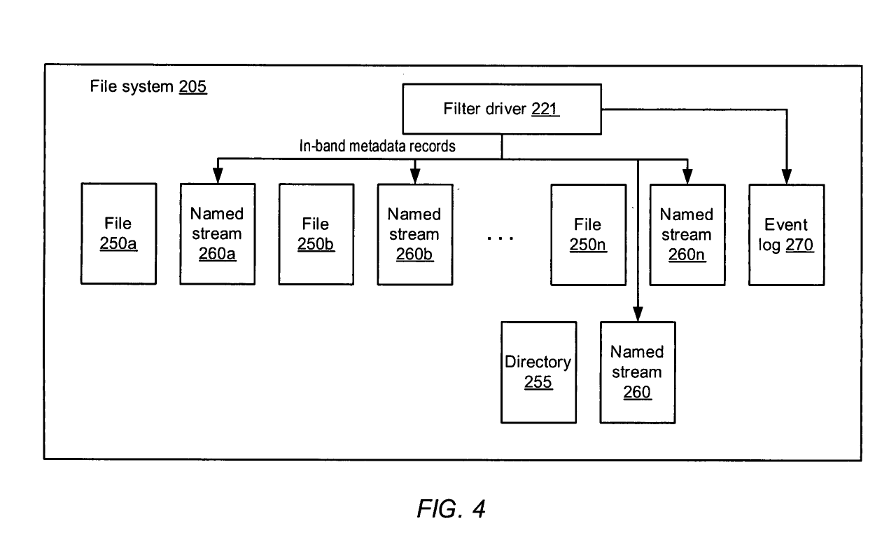

FIG. 4 illustrates one embodiment of a file system configured to store files and associated metadata (i.e., to store file system content). The embodiment of file system 205 shown in FIG. 4 may include those elements illustrated in the embodiment of FIG. 3; however, for sake of clarity, some of these elements are not shown. In the illustrated embodiment, file system 205 includes filter driver 221, an arbitrary number of files 250a-n, a directory 255, a respective named stream 260a-n associated with each of files 250a-n, a respective named stream 260 associated with directory 255, and an event log 270. It is noted that a generic instance of one of files 250a-n or named streams 260a-n may be referred to respectively as a file 250 or a named stream 260, and that files 250a-n and named streams 260a-n may be referred to collectively as files 250 and named streams 260, respectively. As noted above, files 250 and named streams 260 may collectively be referred to as file system content. In some embodiments, directory 255 may also be included as part of file system content.

Files 250 may be representative of files managed by file system 205, and may in various embodiments be configured to store various types of data and program instructions as described above. In hierarchical implementations of file system 205, one or more files 250 may be included in a directory 255 (which may also be referred to as a folder). In various embodiments, an arbitrary number of directories 255 may be provided, and some directories 255 may be configured to hierarchically include other directories 255 as well as files 250. In the illustrated embodiment, each of files 250 and directory 255 has a corresponding named stream 260. Each of named streams 260 may be configured to store metadata pertaining to its corresponding file. It is noted that files 250, directory 255 and named streams 260 may be physically stored on one or more storage devices, such as storage devices 230 of FIG. 2. However, for purposes of illustration, files 250, directory 255 and named streams 260 are shown as conceptually residing within file system 205. Also, it is contemplated that in some embodiments directory 255 may be analogous to files 250 from the perspective of metadata generation, and it is understood that in such embodiments, references to files 250 in the following discussion may also apply to directory 255.

In some embodiments, filter driver 221 may be configured to access file data stored in a given file 250. For example, filter driver 221 may be configured to detect read and/or write operations received by file system 205, and may responsively cause file data to be read from or written to a given file 250 corresponding to the received operation. In some embodiments, filter driver 221 may be configured to generate in-band metadata corresponding to a given file 250 and to store the generated metadata in the corresponding named stream 260. For example, upon detecting a file write operation directed to given file 250, filter driver 221 may be configured to update metadata corresponding to the last modified time of given file 250 and to store the updated metadata within named stream 260. Also, in some embodiments filter driver 221 may be configured to retrieve metadata corresponding to a specified file on behalf of a particular application.

Metadata may be generated in response to various types of file system activity initiated by processes 112 of FIG. 2. In some embodiments, the generated metadata may include records of arbitrary complexity. For example, in one embodiment filter driver 221 may be configured to detect various types of file manipulation operations such as file create, delete, rename, and/or copy operations as well as file read and write operations. In some embodiments, such operations may be detected in-band as described above. After detecting a particular file operation, filter driver 221 may be configured to generate a record of the operation and store the record in the appropriate named stream 260 as metadata of the file 250 targeted by the operation.

More generally, any operation that accesses any aspect of file system content, such as, for example, reading or writing of file data or metadata, or any or the file manipulation operations previously mentioned, may be referred to as a file system content access operation or event, or more simply as a content access operation. In some embodiments, it is contemplated that file system 205 may aggregate or combine multiple input/output (I/O) operations received for a given file, e.g. from a given process 112, into a single content access operation. For example, multiple read or write operations may be aggregated into a single read or write content access operation. In other embodiments, individual I/O operations on files may map more directly to individual content access operations.

Information indicative of a content access operation directed to a particular file 250 may be referred to generally as content access information associated with that file 250, and content access information generally may be said to depend on the content access operation or operations indicated by the information. In one embodiment, filter driver 221 may be configured to generate a metadata record including content access information in response to detecting a file system content access operation. It is contemplated that in some embodiments, access operations targeting metadata may themselves generate additional metadata. As described in greater detail below, in the illustrated embodiment, event log 270 may be configured to store records of detected file system content access operations independently of whether additional metadata is stored in a particular named stream 260 in response to operation detection.

The stored metadata record may in various embodiments include various kinds of information about the file 250 and the operation detected, such as the identity of the process generating the operation, file identity, file type, file size, file owner, and/or file permissions, for example. In one embodiment, the record may include a file signature indicative of the content of file 250. A file signature may be a hash-type function of all or a portion of the file contents and may have the property that minor differences in file content yield quantifiably distinct file signatures. For example, the file signature may employ the Message Digest 5 (MD5) algorithm, which may yield different signatures for files differing in content by as little as a single bit, although it is contemplated that any suitable signature-generating algorithm may be employed. The record may also include additional information other than or instead of that previously described.

In one embodiment, the metadata record stored by filter driver 221 subsequent to detecting a particular content access operation may be generated and stored in a format that may include data fields along with tags that describe the significance of an associated data field. Such a format may be referred to as a “self-describing” data format. For example, a data element within a metadata record may be delimited by such tag fields, with the generic syntax:
<descriptive_tag>data element</descriptive_tag>
   where the “descriptive-tag” delimiter may describe some aspect of the “data element” field, and may thereby serve to structure the various data elements within a metadata record. It is contemplated that in various embodiments, self-describing data formats may employ any of a variety of syntaxes, which may include different conventions for distinguishing tags from data elements.

Self-describing data formats may also be extensible, in some embodiments. That is, the data format may be extended to encompass additional structural elements as required. For example, a non-extensible format may specify a fixed structure to which data elements must conform, such as a tabular row-and-column data format or a format in which the number and kind of tag fields is fixed. By contrast, in one embodiment, an extensible, self-describing data format may allow for an arbitrary number of arbitrarily defined tag fields used to delimit and structure data. In another embodiment, an extensible, self-describing data format may allow for modification of the syntax used to specify a given data element. In some embodiments, an extensible, self-describing data format may be extended by a user or an application while the data is being generated or used.

In one embodiment, Extensible Markup Language (XML) format, or any data format compliant with any version of XML, may be used as an extensible, self-describing format for storing metadata records, although it is contemplated that in other embodiments, any suitable format may be used, including formats that are not extensible or self-describing. XML-format records may allow arbitrary definition of record fields, according to the desired metadata to be recorded. One example of an XML-format record is as follows:

<record sequence =“4”>

<path>/test1/fourth.xls</path>
<type>application/vnd ms-excel</type>
<user id=“1598”>dhruba</user>
<group id=“119”>fcf</group>
<perm>rwxrwxr-x</perm>
<md5>af662188a09d0b9998f710d744918bfe</md5>
<size>15360</size>
<date sec=“1055278487”>2003-06-10T2054:47Z</date>
<io>

<write>append</write>

</io>
<process>

<name>smbd</name>
<args>/opt/VRTSsamba/bin/smbd -D
-s/opt/VRTSsamba/lib/smb.conf</args>
<pid>393</pid>
<ppid>376</ppid>
<pgrpid>376</pgrpid>

</process>

</record>

Such a record may be appended to the named stream (for example, named stream 260a) associated with the file (for example, file 250a) having the file identity “/test1/fourth.xls” subsequent to, for example, an appending write operation. In this case, the number associated with the “record sequence” field indicates that this record is the fourth record associated with file 250a. The “path” field includes the file identity, and the “type” field indicates the file type, which in one embodiment may be provided by the process issuing the file create operation, and in other embodiments may be determined from the extension of the file name or from header information within the file, for example. The “user id” field records both the numerical user id and the textual user name of the user associated with the process issuing the file create operation, and the “group id” field records both the numerical group id and the textual group name of that user. The “perm” field records file permissions associated with file 250a in a format specific to the file system 205 and/or the operating system. The “md5” field records an MD5 signature corresponding to the file contents, and the “size” field records the length of file 250a in bytes.

Additionally, the “date” field records the date and time the record was created. The “io” field records information about the type of content access operation performed, and may include subfields specific to the operation type such as “read” and/or “write”; the “write” subfield may further delimit information regarding the type of write, such as “append” or “random.” The “process” field may include subfields recording information about the process performing the content access operation. The “name” subfield records the name of the process, and the “args” subfield records the arguments given when the process was invoked. The “pid,” “ppid,” and “pgrpid” subfields record the process ID, the ID of the parent of the process, and the group ID of the process, respectively.

It is contemplated that in alternative embodiments, filter driver 221 may store content access information records corresponding to detected operations where the records include more or fewer fields, as well as fields having different definitions and content. It is also contemplated that in some embodiments filter driver 221 may encapsulate data read from a given file 250 within the XML format, such that read operations to files may return XML data regardless of the underlying file data format. Likewise, in some embodiments filter driver 221 may be configured to receive XML format data to be written to a given file 250. In such an embodiment, filter driver 221 may be configured to remove XML formatting prior to writing the file data to given file 250.

It is noted that in some embodiments, metadata may be stored in a structure other than a named stream. For example, in one embodiment metadata corresponding to one or more files may be stored in another file in a database format or another format. Also, it is contemplated that in some embodiments, other software modules or components of file system 205 may be configured to generate, store, and/or retrieve metadata. For example, the metadata function of filter driver 221 may be incorporated into or duplicated by another software module.

In the illustrated embodiment, file system 205 includes event log 270. Event log 270 may be a named stream similar to named streams 260; however, rather than being associated with a particular file, event log 270 may be associated directly with file system 205. In some embodiments, file system 205 may include only one event log 270, while in other embodiments, more than one event log 270 may be provided. For example, in one embodiment of file system 205 including a plurality of local file systems 240 as illustrated in FIG. 2, one history stream per local file system 240 may be provided.

In some embodiments, filter driver 221 may be configured to store a metadata record in event log 270 in response to detecting a file system operation or event. For example, a read or write operation directed to a particular file 250 may be detected, and subsequently filter driver 221 may store a record indicative of the operation in event log 270. In some embodiments, filter driver 221 may be configured to store metadata records within event log 270 regardless of whether a corresponding metadata record was also stored within a named stream 260. In some embodiments event log 270 may function as a centralized history of all detected operations and events transpiring within file system 205.

Similar to the records stored within named stream 260, the record stored by filter driver 221 in event log 270 may in one embodiment be generated in an extensible, self-describing data format such as the Extensible Markup Language (XML) format, although it is contemplated that in other embodiments, any suitable format may be used. As an example, a given file 250a named “/test1/foo.pdf” may be created, modified, and then renamed to file 250b “/test1/destination.pdf” in the course of operation of file system 205. In one embodiment, event log 270 may include the following example records subsequent to the rename operation:

<record>

<op>create</op>
<path>/test1/foo.pdf</path>

</record>
<record>

<op>modify</op>
<path>/test1/foo.pdf</path>

</record>
<record>

<op>rename</op>
<path>/test1/destination.pdf</path>
<oldpath>/test1/foo.pdf</oldpath>

</record>

In this example, the “op” field of each record indicates the operation performed, while the “path” field indicates the file identity of the file 250a operated on. In the case of the file rename operation, the “path” field indicates the file identity of the destination file 250b of the rename operation, and the “oldpath” field indicates the file identity of the source file 250a. It is contemplated that in alternative embodiments, filter driver 221 may store within event log 270 records including more or fewer fields, as well as fields having different definitions and content.
Searching File System Content

The file system content stored and managed by file system 205 may be accessed, for example by processes 112, in a number of different ways. As shown in FIG. 2, processes 112 may interact directly with storage management system 200 via API 114A. For example, if a process 112 knows the specific identity of a file 250 it wishes to access, it may directly open and read that file 250 via API calls provided by storage management system 200. However, in some embodiments processes 112 may desire to access file system content according to a particular criterion or set of criteria. For example, a given process 112 may be interested in identifying those files 250 that include a particular text string.

In the embodiment illustrated in FIG. 2, search engine 400 may be configured to search file system content on behalf of processes 112 and to identify content that matches specified criteria. For example, in one embodiment search engine 400 may be configured to search files 250 for text patterns or regular expressions specified by processes 112 requesting searches. If a portion of given file 250 matches a text pattern or regular expression specified for a given search, search engine 400 may include given file 250, or an indication of given file 250 such as its pathname and filename or another type of file identifier, in a search result set corresponding to the given search. It is contemplated that the result set for a given search may be indicated in a number of ways. In some embodiments, only a file name or unique identifier may be indicated. In other embodiments, some or all of the content and/or metadata associated with a file may be indicated in the result set, instead of or in addition to a file name or other identifier. For example, in one embodiment search engine 400 may be configured to excerpt those passages of a text document that include the terms satisfying a given search, and to include those excerpts (in some cases, up to a limit of a certain number of characters) in the result set along with the file name or other identifier.

In some embodiments, search engine 400 may be configured to perform searches that specify a combination of terms or patterns joined with Boolean or other predicates, such as AND, OR, NOT, or NEAR. For example, a search for files satisfying the search pattern (“quarterly report” AND “FY 2003”) may return a result set including the names of those files 250 including both text strings. In various embodiments, search engine 400 may provide other features or predicates to qualify pattern matching, or may implement a query language such as a version of Structured Query Language (SQL), Extensible Markup Language (XML) Query Language (XQuery), or another suitable query language. In some embodiments, metadata corresponding to files 250 as well as the data content of files 250 may be searched.

In some cases, more than one file 250 may satisfy a given search. Correspondingly, a result set of the given search may indicate several files 250. However, not all of the files 250 in the result set may be equally relevant to the given search. For example, a document that includes specified search terms close to the beginning of the document, or in a particular field of the document such as a title or abstract, may be more likely to be of interest than a document that includes specified search terms later in the document or in a footnote or bibliographic reference. In some embodiments, as described in greater detail below, search engine 400 may be configured to take indications of relevance into account when presenting search results, for example by ordering search results to indicate the most relevant files 250 first.

The relevance of a particular file 250 to a given search may be determined by various characteristics of the content of that particular file, such as the location of the search terms within the file as described above. However, in some instances, characteristics of a file 250 not directly determinable from its content may affect its relevance. For example, a frequently accessed file may be more relevant than another file with similar content but that is less frequently accessed. How frequently a file 250 is accessed, as well as other information about how a file 250 is accessed (e.g., the user or process performing the access, the access time, etc.) may be stored in some embodiments as content access information, either in metadata associated with a particular file 250 or elsewhere within file system content. In some embodiments the relevance of a given file 250 may depend upon content access information corresponding to given file 250.

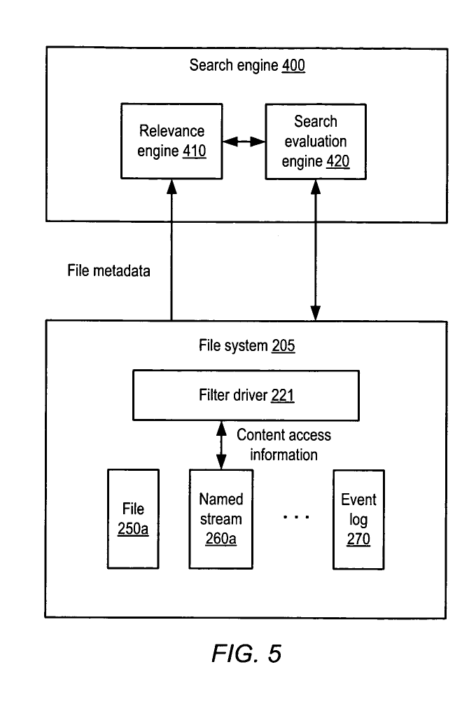

One embodiment of a system configured to perform content access information-based search relevance determination is illustrated in FIG. 5. In the illustrated embodiment, search engine 400 includes a relevance engine 410 configured to interface with file system 205 to transfer information, as well as a search evaluation engine 420 also configured to interface with file system 205. It is noted that although only file 250a and named stream 260a are shown within file system 205, it is contemplated that file system 205 may include arbitrary numbers of files 250 and named streams 260 in addition to other elements, as described above in conjunction with the description of FIG. 4. It is also noted that while specific types of information exchange are illustrated between search engine 400 and file system 205, other types of information exchange may take place within these entities as well as between these entities and other entities not shown. Additionally, in some embodiments, the functions of relevance engine 410 and search evaluation engine 420 may be provided by a single software module or distributed among a group of other software modules.

In one embodiment, relevance engine 410 may be configured to determine a relevance indication associated with a given file 250. For example, relevance engine 410 may be configured to produce a numerical index (e.g., an integer from 0 to 100, a fraction from 0 to 1, or any other numerical indication) or another suitable type of relevance indication associated with each file that is indicated in the result set of a given search operation. In some embodiments, relevance engine 410 may be configured to determine file relevance indications after search evaluation engine 420 has produced a result set (if, for example, more than one file 250 is indicated in the result set). In other embodiments, relevance engine 410 may be configured to determine file relevance indications during the operation of search evaluation engine 420. For example, while evaluating a given search, search evaluation engine 420 may be configured to walk through all or portions of the file system content managed by file system 205. In one embodiment, while search evaluation engine 420 is evaluating a given file system content item to determine whether it satisfies the given search, relevance engine 410 may be configured to concurrently determine a relevance indication of the content item. In still other embodiments, search engine 400 may be configured to index file system content, and relevance engine 410 may be configured to determine relevance indications during indexing rather than during or after search evaluation.

In the illustrated embodiment, filter driver 221 may be configured to generate metadata records (i.e., file system content) including content access information, where the content access information is dependent upon content access operations associated with files 250. For example, in response to detecting a content access operation directed to a particular file 250, filter driver 221 may be configured to generate a metadata record including content access information associated with the detected operation, and to store the record in a named stream 260 associated with the particular file 250. As described above, such content access information may variously include any information pertinent to the content access operation.

Relevance engine 410, in the illustrated embodiment, may be configured to receive from named stream 260 content access information generated by filter driver 221 and to determine a relevance indication associated with corresponding file 250 dependent upon the content access information. For example, in one embodiment relevance engine 410 may be configured to receive all or a portion of the metadata records stored in named stream 260, either in response to requesting the records or in response to new records being generated, depending on the implementation. Relevance engine 410 may then parse the received content access information to determine a corresponding relevance indication. For example, for a search performed by a given user, relevance engine 410 may be configured to assign a higher degree of relevance to files 250 whose content access information indicates access operations performed by that given user. In some embodiments, relevance engine 410 may be configured to discard content access information after a relevance indication has been determined for a given file 250, while in other embodiments, content access information may be preserved, for example through indexes of file system content.

Relevance engine 410 may be configured to determine relevance indications according to other aspects of content access information. In various embodiments, one or more of the following types of content access information (which variously may be stored explicitly within metadata records in named streams 260, or derived from other content access information so stored) may affect the relevance indication associated with a file 250:

Number of content access operations occurring to a file

Number of different users accessing a file

Number of users from different groups accessing a file

Number of different applications accessing a file

Number of copies of a file in different locations (as may be determined by, e.g., file signatures)

Whether a file is accessed by a process group leader (e.g., a daemon process)

Number of processes from different process groups accessing a file

Degree of access permissions on a file

Number of replication sites of a file

Depth of a file within a file hierarchy

Time of last content access operation to a file

For example, in one embodiment, if a particular file 250 has a large number of recent accesses by a large number of different users as reflected by its content access information, relevance engine 410 may assign that file a higher relevance indication (e.g., an index closer to 100 than 0). By contrast, if a particular file 250 has not been accessed for several months and has restrictive access permissions (e.g., is readable only by its owner), relevance engine 410 may assign that file a lower relevance indication (e.g., an index closer to 0 than 100). In addition to or instead of the aspects listed above, in various embodiments it is contemplated that numerous other content access-related aspects of files 250 may be combined in any suitable fashion to determine relevance indications.

In some instances, information about how storage elements underlying a particular file 250 are configured may be useful in determining the relevance of that file. For example, a file 250 stored on mirrored or replicated storage may be more relevant to a particular query than a file 250 that is neither mirrored nor replicated. Similarly, a file 250 stored on a faster storage device or a device accessible through a high-speed data network (such as a Storage Area Network (SAN) fabric, for example) may be more relevant than a file 250 stored on a slower storage device or a device accessible through a lower-bandwidth or higher-latency network (such as a Wide Area Network (WAN), for example). In some embodiments, content access information associated with a given file 250 may include metadata indicative of characteristics of storage underlying given file 250, such as whether the underlying storage is mirrored, striped, or replicated, an indication of the access latency, bandwidth, or quality of service of underlying storage devices or networks associated with such devices, or any other suitable storage characteristic. Such metadata may be generated as in-band metadata by filter driver 221 or as out-of-band metadata by another module of file system 205. In such embodiments, content access information pertinent to storage characteristics may be included along with or instead of other types of content access information (such as those given above, for example) in determining a relevance indication associated with a given file 250.

In some embodiments, the specific relevance indication determined for a given file 250 may be influenced both by content access information and by content-specific information, such as the location of search terms within result content as previously described. Additionally, in some embodiment the specific relevance indication determined for a given file 250 may be dependent upon parameters specific to a given search. For example, a file 250 may be more or less relevant for a given search depending whether a user ID included in content access information of the file 250 matches the user ID of the user performing the search, which may be specified as a parameter of a search operation. Further, in some embodiments, search engine 400 may be configured to allow users to specify parameters for a search operation that indicate what content access information should or should not be taken into account when determining search result relevance. For example, a user may specify a parameter that specifically excludes content access information indicative of storage characteristics (such as described in the previous paragraph) from being used to determine relevance indications for a particular search operation.

In the illustrated embodiment, search evaluation engine 420 may be configured to evaluate searches with respect to file system content and to return search results to requesting processes or applications. For example, search evaluation engine 420 may be configured to parse a given search string or pattern, to identify file system content satisfying the given search pattern, and to provide the names of files 250 satisfying the given search pattern. In some embodiments, search evaluation engine 420 may be configured to consult indexes maintained by search engine 400 in order to quickly identify file system content satisfying the given search pattern.

In some embodiments, search engine 400 may be configured to present search results dependent upon content access information. For example, in the illustrated embodiment, relevance engine 410 may be configured to order the files 250 indicated in the result set of a given search dependent upon the relevance indications associated with those files 250. In turn, the relevance indications may be dependent upon content access information as described above. In other embodiments, other aspects of search result presentation may be dependent upon content access information. For example, instead of or in addition to ordering search results based on relevance, the relevance indication corresponding to a given file 250 may be presented (e.g., as a numerical value or a graphical indicator such as a bar graph) along with an indication of given file 250, such as a file name and/or pathname.

Configuring search engine 400 to receive content access information and to determine relevance indications dependent upon the received content access information, as described above and illustrated in FIG. 5, in some embodiments may entail modifying the interface between search engine 400 and storage management system 200. For example, in one embodiment, search engine 400 may be configured to receive and parse XML data in order to receive content access information. Further, search engine 400 may be specifically configured to include algorithms for determining relevance indications dependent upon content access information. For example, search engine 400 may determine relevance as a function of several different types of content access information, as described above.

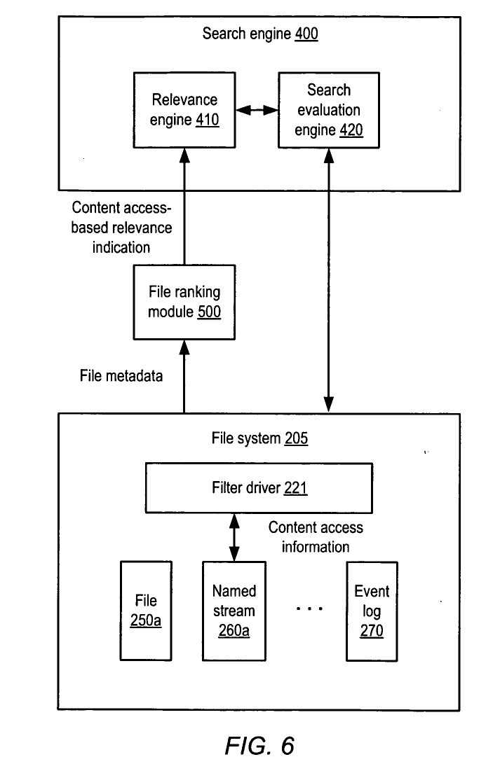

However, in some embodiments, it may not be possible or feasible to directly modify the interface or behavior of search engine 400 at all, or to the degree necessary for search engine 400 to directly receive content access information associated with file system content. For example, in some embodiments search engine 400 may include proprietary, third-party software for which the source code is not available to be modified. Alternatively, the complexity of search engine 400 may be such that substantial (or any) modification is impractical or difficult to test. In the embodiment illustrated in FIG. 6, relevance indications dependent upon content access information may be determined externally to search engine 400, which in some instances may reduce or eliminate the need to modify search engine 400.

The system illustrated in FIG. 6 is similar to that shown in FIG. 5, with the exception that file ranking module 500 is interposed between query system 400 and file system 205. In some embodiments, module 500 may be implemented within storage management system 200, while in other embodiments module 500 may be implemented as a separate layer of software between storage management system 200 and search engine 400.

In one embodiment, module 500 may be configured to receive content access information from file system 205, such as metadata records stored in named streams 260. Module 500 may be further configured to determine a content access-based relevance indication corresponding to a given file 250. In various embodiments, the content access-based relevance indication may take into account any of the types of content access information listed above, as well as any other suitable types of content access information that may be available (e.g., for which filter driver 221 is configured to detect and generate a corresponding record).

In the illustrated embodiment, the content access-based relevance indication produced by module 500 may be generated in a format that is native to search engine 400, or that requires fewer modifications to search engine 400 than directly providing detailed content access information might require. For example, in one embodiment relevance engine 410 may provide a built-in interface to receive an external relevance indication formatted as a numerical index in a specified range, such as an integer from 0 to 100. In such an embodiment, module 500 may be-configured to format its content access-based relevance indication accordingly, and to pass the indication to relevance engine 410 as a parameter. Relevance engine 410 may then take the supplied relevance indication into account when determining result relevance. For example, in one embodiment relevance engine 410 may consider content-based relevance (such as the location of search terms within specific file system content) as well as content access-based relevance as indicated by module 500 when determining how to present search results. It is contemplated that in various embodiments, search engine 400 may provide other types of interfaces configured to receive differently formatted content access-based relevance indications.

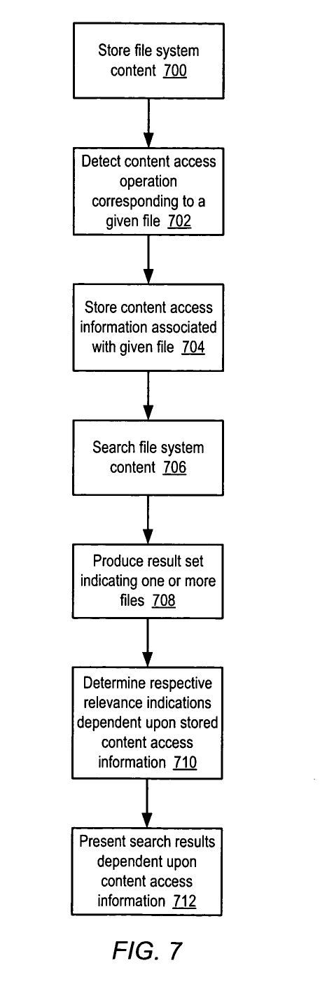

One embodiment of a method of associating content access-based relevance with file system content is illustrated in FIG. 7. Referring collectively to FIG. 1 through FIG. 7, operation begins in block 700 where file system content is stored. For example, a particular application process 112 may be configured to create or write to a file 250 managed by file system 205.

Subsequently, a content access operation corresponding to a given file is detected (block 702). For example, a read or write to a file 250 may be detected. In some embodiments, as noted above, a content access operation may include operations that access file metadata or that modify a file itself (e.g., file create, delete, rename operations). In response to detecting the content access operation, content access information associated with the accessed file is stored (block 704). For example, in one embodiment a metadata record including content access information may be stored in XML format in a named stream 260 associated with an accessed file 250.

File system content is then searched (block 706). For example, in one embodiment search engine 400 may receive a search pattern from an application process 112. In response to the search, a result set indicating one or more files 250 is produced (block 708). (In some instances, a search may yield no results, and in some embodiments processing may terminate if no results are produced.)

In the illustrated embodiment, a respective relevance indication associated with each of the files 250 included in the result set is determined dependent upon stored content access information (block 710). For example, in one embodiment search engine 400 may be configured to receive stored content access information directly from a named stream 260 associated with a given file 250, and to determine a relevance indication using the content access information. In another embodiment, determination of the content access-based relevance indications may be performed externally to search engine 400, for example in module 500. It is noted that in various embodiments, determining relevance indications may occur subsequent to a particular search operation (e.g., only on the result set), concurrently with a search operation, or independently of a search operation (e.g., during indexing), as described above.

Search results are then presented dependent upon stored content access information (block 712). For example, in one embodiment search engine 400 may be configured to order the result set dependent upon corresponding relevance indications, which in turn depend upon content access information.

In other embodiments, it is contemplated that some of the steps illustrated in FIG. 7 may be performed in a different order or a different number of times. For example, multiple files may be stored and/or content access operations initiated prior to a search occurring. Also, it is contemplated that any of the elements or methods illustrated in FIG. 2-7, including file system 205, search engine 400, module 500 and their various methods of operation, may be implemented as program instructions and data stored and/or conveyed by a computer-accessible medium as described above.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system, comprising:
a storage device configured to store data;
a file system configured to manage access to said storage device and to store file system content including a plurality of files; and
a search engine configured to search said file system content and to produce a result set indicating one or more of said plurality of files;
wherein each of said files indicated in said result set is associated with a respective relevance indication; and
wherein a given relevance indication is dependent upon content access information corresponding to said associated file.

2. The system as recited in claim 1, wherein said search engine is further configured to order said files indicated in said result set dependent upon said respective relevance indications.

3. The system as recited in claim 1, wherein said file system is further configured to detect a content access operation corresponding to a given one of said plurality of files and to responsively store content access information in metadata associated with said given file.

4. The system as recited in claim 3, wherein said content access information is stored in a data format compliant with a version of Extensible Markup Language (XML) format.

5. The system as recited in claim 3, wherein said metadata is stored in a named stream corresponding to said given file.

6. The system as recited in claim 3, wherein said search engine is further configured to receive said content access information and to determine a relevance indication associated with said given file dependent upon said content access information.

7. The system as recited in claim 3, further comprising a file ranking module interposed between said search engine and said file system, wherein said file ranking module is configured to receive said content access information and to determine a relevance indication associated with said given file dependent upon said content access information.

8. A method, comprising:
storing file system content including a plurality of files;
searching said file system content; and
in response to searching said file system content, producing a result set indicating one or more of said plurality of files;
wherein each of said files indicated in said result set is associated with a respective relevance indication; and
wherein a given relevance indication is dependent upon content access information corresponding to said associated file.

9. The method as recited in claim 8, further comprising ordering said files indicated in said result set dependent upon said respective relevance indications.

10. The method as recited in claim 8, further comprising:
detecting a content access operation corresponding to a given one of said plurality of files;
in response to said detecting, storing content access information in metadata associated with said given file.

11. The method as recited in claim 10, wherein said content access information is stored in a data format compliant with a version of Extensible Markup Language (XML) format.

12. The method as recited in claim 10, wherein said metadata is stored in a named stream corresponding to said given file.

13. The method as recited in claim 10, wherein searching said file system content is performed by a search engine, and wherein the method further comprises:
said search engine receiving said content access information; and
said search engine determining a relevance indication associated with said given file dependent upon said content access information.

14. The method as recited in claim 10, wherein searching said file system content is performed by a search engine, and wherein the method further comprises:
a file ranking module interposed between said search engine and said file system content receiving said content access information;
said file ranking module determining a relevance indication associated with said given file dependent upon said content access information.

15. A computer-accessible medium comprising program instructions, wherein the program instructions are executable to:
store file system content including a plurality of files;
search said file system content; and
in response to searching said file system content, produce a result set indicating one or more of said plurality of files;
wherein each of said files indicated in said result set is associated with a respective relevance indication; and
wherein a given relevance indication is dependent upon content access information corresponding to said associated file.

16. The computer-accessible medium as recited in claim 15, wherein the program instructions are further executable to order said files indicated in said result set dependent upon said respective relevance indications.

17. The computer-accessible medium as recited in claim 15, wherein the program instructions are further executable to:
detect a content access operation corresponding to a given one of said plurality of files;
in response to said detecting, store content access information in metadata associated with said given file.

18. The computer-accessible medium as recited in claim 17, wherein said content access information is stored in a data format compliant with a version of Extensible Markup Language (XML) format.

19. The computer-accessible medium as recited in claim 17, wherein said metadata is stored in a named stream corresponding to said given file.

20. The computer-accessible medium as recited in claim 17, wherein searching said file system content is performed by a search engine, and wherein the program instructions are further executable to implement:
said search engine receiving said content access information; and
said search engine determining a relevance indication associated with said given file dependent upon said content access information.

21. The computer-accessible medium as recited in claim 17, wherein searching said file system content is performed by a search engine, and wherein the program instructions are further executable to implement:
a file ranking module interposed between said search engine and said file system content receiving said content access information;
said file ranking module determining a relevance indication associated with said given file dependent upon said content access information.

22. A system, comprising:
a storage device configured to store data;
a file system configured to manage access to said storage device and to store file system content including a plurality of files, wherein said file system content further includes content access information dependent upon content access operations associated with said plurality of files; and
a search engine configured to search said file system content and to present results dependent upon said content access information.
